(19) United States
(12) Patent Application Publication
(10) Pub. No.: US 2009/0147752 A1
(43) Pub. Date: Jun. 11, 2009

(54) Method, apparatus and system for assigning internet protocol address in communication system based on media independent handover

(75) Inventors: Young-Don Chung, Seoul (KR); Jeong-Jae Won, Hwaseong-si (KR); Eui-Seok Hwang, Hwaseong-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/313,519

(22) Filed: Nov. 21, 2008

(30) Foreign Application Priority Data
Nov. 23, 2007 (KR) 10-2007-0120042

(51) Int. Cl. H04W 36/00

(52) U.S. Cl. 370/331

(57) ABSTRACT

Provided is a method, apparatus and system for assigning an IP address in a communication system based on a Media Independent Handover (MIH). In the method, information about a neighbor network is obtained through an MIH service. In the event of a handover to a heterogeneous network, one or more New Care of Addresses (NCoAs) are generated using the information about the neighbor network. The generated NCoA is transmitted to a candidate network through the MIH service. A Duplicate Address Detection (DAD) operation is performed on the NCoA.

### CROSS-REFERENCE TO RELATED APPLICATION(S) AND CLAIM OF PRIORITY

The present application claims priority under 35 U.S.C. § 119 to an application filed in the Korean Intellectual Property Office on Nov. 23, 2007 and assigned Serial No. 10-2007-0120042, the contents of which are incorporated herein by reference.

### TECHNICAL FIELD OF THE INVENTION

The present invention relates generally to a method, apparatus and system for assigning an Internet Protocol (IP) address in a communication system based on a Media Independent Handover (MIH) and, in particular, to a method, apparatus and system for receiving subnet information of a candidate group beforehand in the event of a handover to a heterogeneous network in an MIH-based communication system, generating an address on the basis of the received subnet information, detecting whether the generated address is a duplicate address, and assigning a new IP address if the generated address is a duplicate address.

### BACKGROUND OF THE INVENTION

The development of various wired/wireless communication networks and access technologies has increased the users' options for communication access technologies. There is, therefore, an increasing need for an interaction without service interruption between access technologies when using various access technologies. Under such communication environments, the Institute of Electrical and Electronics Engineers (IEEE) 802.21 Working Group (WG) has been established to define the standards for a handover between heterogeneous networks. The IEEE 802.21 WG adopts Media Independent Handover (MIH) protocol as the standard for interworking various broadband access systems without service quality degradation.

Communication networks have developed with distinction of wired networks and wireless networks. The next-generation communication systems are being developed to provide wired/wireless, voice, data, multimedia integrated services and integrated switching networks on the basis of the Internet. An integrated IP-based network structure is being proposed through the concept of All IP.

Thus, to support the mobility of a user terminal supporting a multiple network Interface (I/F) between IP-based heterogeneous networks, the user terminal performs a basic Network Entry (NE) process for the corresponding network while approaching a target network, and then receives a Router Advertisement (RA) message to obtain subnet information of the corresponding network and generate an tentative IPv6 or IPv4 address. The generated address cannot be directly used according to the IPv6 specification, and a Duplicate Address Detection (DAD) process is performed to detect whether another terminal using a duplicate address is present in the corresponding network. In this process, the user terminal must accept a delay of about 1 second until it can use the corresponding address after completion of the DAD process.

FIG. 1 is a diagram illustrating an example of a handover between heterogeneous networks.

Referring to FIG. 1, while moving from a point A 104 in a network A 100 to a point B 110 in a network B 102, a user terminal detects the network B 102 and initiates a network entry at a point A′ 106, and receives an RA message to prepare to assign a new IP address to be used in a new I/F. The user terminal, which has generated a tentative address, communicates through the network B 102 because the network A 100 is not detected after a point B′ 108.

As described above, to receive a service from the corresponding network, the user terminal performs a network entry process, a DAD process and an address registration process after detection of the corresponding network through an I/F. Assuming that times a, b and c are respectively taken to perform the network entry process, the DAD process and the address registration process and a time t 112 is taken to move from the point A′ 106 to the point B′ 108, the following equation must be satisfied to provide a seamless handover from the network A 100 to the network B 102.

a+b+c≦t,

where a denotes a time taken for the network entry process, b denotes a time taken for the DAD process, and c denotes a time taken for the address registration process.

The problem of interworking heterogeneous networks using a multiple network I/F is that a packet loss may occur because a connection with the network A 100 is interrupted before completion of the establishment of an access to the network B 102 if the time t 112 is short. That is, a packet loss may occur because both of the connections with the network A 100 and the network B102 are interrupted before completion of the network entry process, the DAD process and the address registration process.

### SUMMARY OF THE INVENTION

To address the above-discussed deficiencies of the prior art, it is a primary object of the present invention to substantially solve at least the above problems and/or disadvantages and to provide at least the advantages below. Accordingly, an object of the present invention is to provide a method, apparatus and system for obtaining subnet information of a candidate group beforehand through an MIH service in the event of a handover to a heterogeneous network in an MIH-based communication system, generating an address on the basis of the obtained subnet information, detecting whether the generated address is a duplicate address, and assigning a new IP address if the generated address is a duplicate address.

Another object of the present invention is to provide a method and apparatus for supporting IP-based seamless mobility between heterogeneous networks in an MIH-based communication system.

According to an aspect of the present invention, a method for assigning an Internet Protocol (IP) address in a communication system based on a Media Independent Handover (MIH) includes: obtaining information about a neighbor network through an MIH service; generating, in the event of a handover to a heterogeneous network, one or more New Care of Addresses (NCoAs) by using the information about the neighbor network; transmitting the generated NCoA to a candidate network through the MIH service; and performing a Duplicate Address Detection (DAD) operation on the NCoA.

According to another aspect of the present invention, a method for an operation of a user terminal to assign an IP address in an MIH-based communication system includes: obtaining information about a neighbor network through an MIH service; generating, in the event of a handover to a heterogeneous network, one or more NCoAs by using the information about the neighbor network; and transmitting the generated NCoA to a candidate network through the MIH service.

According to still another aspect of the present invention, a system for assigning an IP address in an MIH-based communication system includes: a user terminal for obtaining information about a neighbor network through an MIH service, generating, in the event of a handover between heterogeneous networks, one or more NCoAs by using the information about the neighbor network, and transmitting the generated NCoA to a candidate network through the MIH service; and a candidate base station for performing a DAD operation on the NCoA.

According to even another aspect of the present invention, an apparatus for a base station to assign an IP address in an MIH-based communication system includes: an inter-network adapter for receiving, in the event of a handover between heterogeneous networks, one or more NCoAs from a user terminal through an MIH service; and a user layer for performing a DAD operation on the NCoA and notifying the results of the DAD operation to the user terminal.

According to yet another aspect of the present invention, an apparatus for a user terminal to assign an IP address in an MIH-based communication system includes: an inter-network adapter for obtaining information about a neighbor network through an MIH service; and a user layer for generating, in the event of a handover to a heterogeneous network, one or more NCoAs by using the information about the neighbor network, and transmitting the generated NCoA to a candidate network through the MIH service.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating an example of a handover between heterogeneous networks;

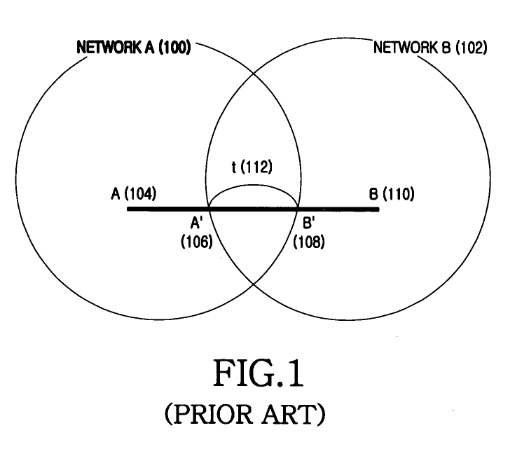

FIG. 2 is a diagram illustrating the relationships between other layers and an MIHF according to the present invention;

FIG. 3 is a flow diagram illustrating a process for assigning an IP address in an MIH-based communication system according to an embodiment of the present invention;

FIG. 4 is a flow diagram illustrating a DAD process according to an embodiment of the present invention;

FIG. 5 is a block diagram of a user terminal according to an embodiment of the present invention; and

FIG. 6 is a block diagram of a base station according to an embodiment of the present invention.

### DETAILED DESCRIPTION OF THE INVENTION

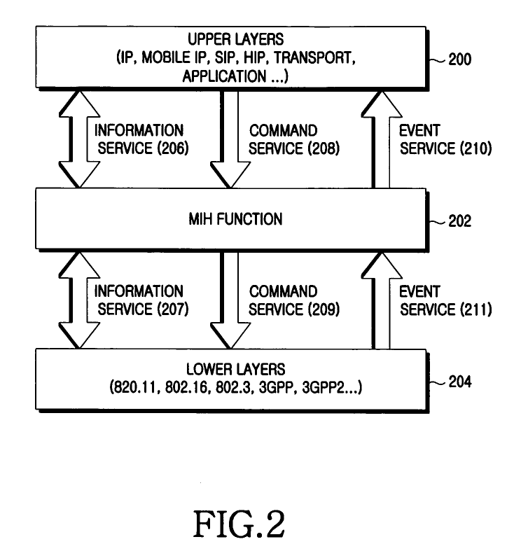

FIGS. 2 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

The present invention provides a method, apparatus and system for assigning an IP address in an MIH-based communication system.

The IEEE 802.21 WG standardizes a Media Independent Handover Function (MIFIF) to support a handover between heterogeneous networks.

FIG. 2 is a diagram illustrating the relationships between other layers and an MIHF according to the present invention.

Referring to FIG. 2, the MIH technology provides three MIHF services and MIH protocol. Through a well-defined Service Access Point (SAP), an MIHF 202 provides a Media Independent Event Service (MIES) 210/211, a Media Independent Command Service (MICS) 208/209, and a Media Independent Information Service (MIIS) 206/207 to upper layers 200/lower layers 204.

The MIESs 210 and 211 are information transmitted from a link layer to the upper layers 200, and the upper layers 200 can receive the information by a registration process. The upper layers 200 including a mobility management protocol need to receive link layer information such as handover preparation/execution/completion. The MIES 210/211 can be classified in to a link event 211 that is generally terminated at the MIHF from an event-generating entity in the lower layers 204, and an MIH event 210 that is transmitted to the upper layers 200 registered by the MIHF. The MICSs 208 and 209 are commands that are transmitted from the upper layers 200 to the lower layers 204 so that the upper layers 200 and other MIH users determine link conditions and control an optimized operation of a multi-mode device. Like the MIESs 210 and 211, the MICSs 208 and 209 are classified into a link command 209 and an MIH command 208. The MIISs 206 and 207 are information about homogeneous or heterogeneous networks in a geographical area. Not only an MIHF of a mobile terminal but also an MIHF of a network can detect and obtain an MIIS. The MIISs 206 and 207 include various information elements that are necessary for making intelligent handover decisions.

The MIH provides event services 210 and 211, command services 208 and 209, and information services 206 and 207 so that a mobile terminal with multiple wireless interfaces can automatically select the available optimal network access type and can perform a flexible hand-off of a session between heterogeneous networks or media.

For the event services 210 and 211, the MIES enables the lower layers 204 (e.g., a medium access control layer and a physical layer) to provide useful information about a handover, a condition change such as a connection establishment release, and a link parameter change. By obtaining such information through event services, the upper layers 200 can make a handover decision and can perform an IP address reset process for a quick handover. The upper layer entities can be notified of the generation/completion of a handover from the lower layer entities. The upper layer entities can be simultaneously interested in various events and register desired events through an event registration process. Thus, the events can be transmitted to a plurality of registered upper layer entities.

For the command services 208 and 209, the MICS provides a command from the upper layer 200 to the lower layer 204. The upper layer entity and the MIHF can use the command service to control a multi-mode terminal or change link conditions for optimal performance improvement. Also, for execution of an optimal handover policy, the command service enables the MIHF to initiate a handover while equalizing the loads of heterogeneous access networks. Most commands defined in the IEEE 802.21 WG are to obtain information from the upper layer. These commands are executed by exchange of a request or response primitive. In a multi-mode terminal, the upper layer entity can mange the conditions of a local link through commands such as MIH Poll, MIH Switch, MIH Configure, and MIH Scan. For example, a mobile terminal can detect and control the conditions of a current or expected local remote link through an MIH Poll command. Also, a mobile terminal can establish or release a local link through an MIH Switch command depending on the handover conditions. Also, the execution of an MIH Configure command can control an operation of the lower layer entity by setting the parameters of a link driver.

Remote MIH commands are transmitted from an MIHF in a local stack to an MIHF in a remote stack. These commands can be exchanged between two MIHF entities (for example, between a mobile terminal and an access point, between access points, and between an access point and an access router). A handover control of an MIH stage can be performed by remote MIH commands such as MIH Handover Initiate, MIH Handover Prepare, and MIH Handover Complete. A mobile terminal can obtain network address information through an MIH Network Address Information command before or after a handover.

For the information services 206 and 207, the MIIS provides network-related information to MIHF users of single network or heterogeneous network environments. This function is essential for network detection or selection, and enables a mobile terminal in an access network to obtain information about another network. In the case of heterogeneous networks, the MIIS can obtain information through remote MIH signal communication although the types of access networks are different. This can also assist a handover policy entity in making an accurate handover decision.

Information resulting from the MIIS includes lower layer information or upper layer information. If lower layer information is insufficient for handover decision, upper layer information may be used and sometimes both the lower layer information and the upper layer information may be used. The information includes information elements and is expressed as a schema to provide various access methods. That is, the information can be obtained through a single schema access. Using this process, mobile terminals can perform a seamless handover by obtaining the next access point information beforehand. The IEEE 802.21 WG defines that the information can be used in an information server or an MIBF but does not specify a strict location. Also, the IEEE 802.21 WG does not consider an access method of the information.

The MIH protocol exchanges MIH packets between the MIHFs of an access router, a mobile terminal, and an access point. An MIH protocol frame format must be defined so that MIHF entities exchange MIH messages. MIH messages exchanged remotely through a media dependent interface are based on a primitive that is a portion of the MIES, the MICS, or the MIIS. Network entities such as mobile terminals, base stations, and access routers include an MIHF and can communicate with each other by using the MIH protocol and the equal entities including the MIHF.

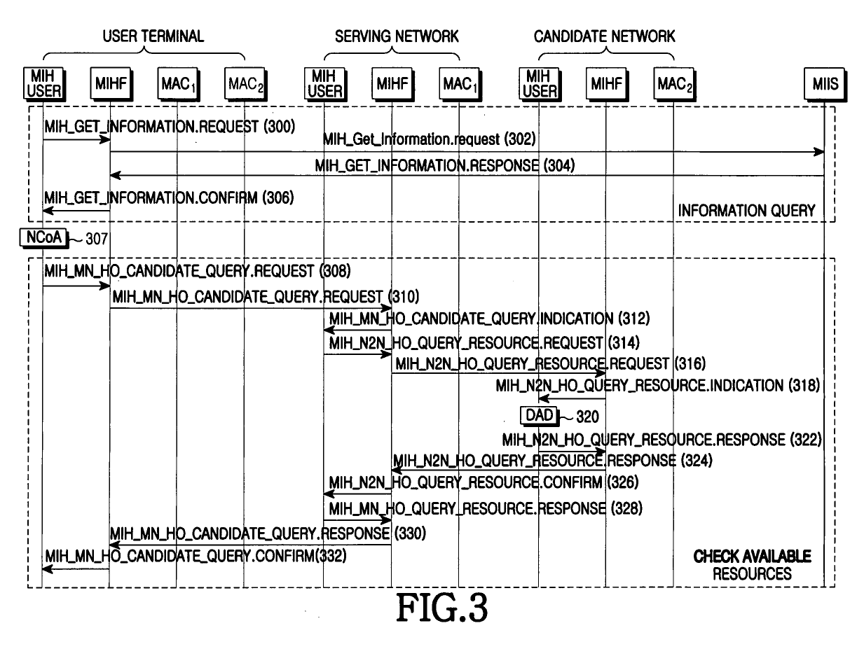

FIG. 3 is a flow diagram illustrating a process for assigning an IPv6 address in an MIH-based communication system according to an embodiment of the present invention.

Referring to FIG. 3, a serving network, a candidate network, an MIIS server, and a user terminal supporting an MIH service are network components for supporting the present invention, and it is assumed that each of the network components (e.g., a user terminal and serving/candidate networks) includes an MIH user, an MIHF, and a Media Access Control (MAC). Herein, the mobile terminal is a dual terminal having a plurality of network interfaces, the MIH user is an entity using a service provided by the MIHF, and the MIHF serves as a service access point (SAP) between an upper layer and a lower layer, which is a function of an MIH service. The MIIS server provides information necessary for the MIH service. Hereinafter, a command transmitted from the MIH user to the MIHF is referred to as an MIH command, and a command transmitted from the MIHF to the MAC is referred to as a link command. Also, a command transmitted from the MIHF to the MIH user is referred to as an MIH event, and a command transmitted from the MAC to the MIHF is referred to as a link event.

Referring to FIG. 3, when a handover is necessary because a mobile terminal moves from a serving network to a target network, a terminal MIH user transmits an MIH_Get_Information Request command for requesting information about a neighbor network to a terminal MIHF in step 300.

In step 302, the terminal MIHF transmits an MIH_Get_Information Request message to an MIIS server.

In step 304, the MIIS transmits an MIH_Get_Information Response message containing information about a neighbor network to the terminal MIHF.

In step 306, the terminal MIHF transmits an MIH_Get_Information Confirm event to the terminal MIH user.

In step 307, the terminal MIH user selects a target network on the basis of the candidate network information contained in the MIH_Get_Information Response message and generates one or more New Care of Addresses (NCoAs) on the basis of the subnet information contained in the corresponding message. The NCoA is a new IP address that is to be used after a handover. Herein, the NCoA can be generated beforehand because the subnet information of the candidate network is contained in the information received through the MIH_Get_Information message.

In step 308, the terminal MIH user transmits an MIH_MN_HO_Candidate_Query Request command to the terminal MIHF. In step 310, the terminal MIHF transmits an MIH_MN_HO_Candidate_Query Request message to a serving MIHF, thereby initiating a handover. This message contains information about a potential candidate network as well as the generated NCoA.

In step 312, the serving MIHF transmits an MIH_MN_HO_Candidate_Query Indication event to a serving MIH user. In step 314, the serving MIH user transmits an MIH_N2N_HO_Query_Resource Request command for resource request to the serving MIBF.

In step 316, the serving MIHF transmits an MIH_N2N_HO_Query_Resource Request message to one or more candidate MIHFs to query whether resource allocation is possible in the candidate network.

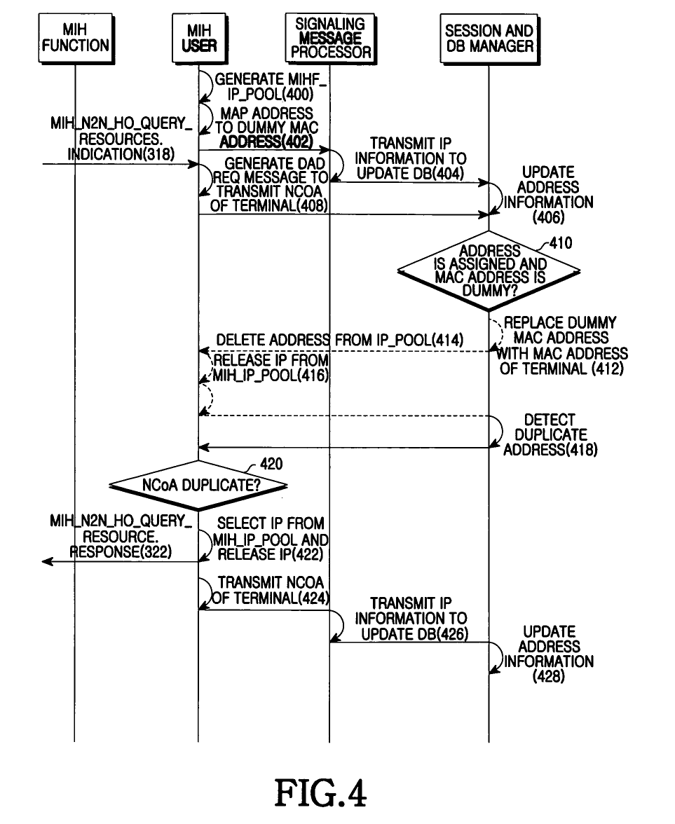

In step 318, the candidate MIHF transmits an MIH_N2N_HO_Query_Resource Indication event to a candidate MIH user. In step 320, the candidate MIH user receives an NCoA and performs a Duplicate Address Detection (DAD) process. If a duplicate address is not present, it uses the NCoA as is. If a duplicate address is present, it allocates another NCoA and prepares so that the terminal can use the same. The DAD process will be described later in detail with reference to FIG. 4.

In step 322, the candidate MIH user transmits an MIH_N2N_HO_Query_Resource Response command to the candidate MIHF. In step 324, the MIHF transmits an MIH_N2N_HO_Query_Resource Response message to the serving MIHF.

In step 326, the serving MIHF transmits an MIH_N2N_HO_Query_Resource Confirm event to the serving MIH user. In step 328, the serving MIH user transmits an MIH_MN_HO_Query_Resource Response command to the serving MIHF.

In step 330, the serving MIHF transmits an MIH_MN_HO_Candidate_Query Response message to the terminal MIHF to notify the mobile terminal of the possible resources available in the candidate network. In step 332, the terminal MIHF transmits an MIH_MN_HO_Candidate_Query Confirm event to the terminal MIH user.

Although not illustrated in FIG. 3, after step 332, the mobile terminal determines a handover target and transmits an MIH_MN_HO_Commit Request message to a serving MIHF to request resource allocation preparation. Thereafter, the serving MIHF transmits an MIH_N2N_HO_Commit request to a target MIHF and requests resource allocation preparation in a target network. The target MIHF responds with the result through an MIH_N2N_HO_Commit Response message. Thereafter, if the resource preparation is successful, the serving MIHF transmits an MIH_MN_HO_Commit Response message to a mobile terminal. Thereafter, a new link connection is established, and the mobility between a mobile terminal and a target network is determined according to a predetermined mobility support protocol process. That is, a mobile terminal transmits an MIH_MN_HO_Complete request to a target MIHF, and the target MIHF transmits an MIH_N2N_HO_Complete request to the previous serving MIHF to release the resources allocated to the mobile terminal. After the resources are successfully released, the target MIHF transmits an MIH_MN_HO_Complete Response message to the mobile terminal, thereby completing the handover.

Thereafter, the process of the present invention is ended.

As described above, in the event of a handover from the MIIS server between heterogeneous networks in the MIH-based communication system, the subnet information of the candidate network is obtained beforehand to generate the NCoA to be used in a new network and the MIH message is used to perform the DAD process for a new address, thereby making it possible to omit an operation of performing DAD by generating an NCoA in an IPv6 layer.

FIG. 4 is a flow diagram illustrating a DAD process according to an embodiment of the present invention.

An MIHF is implemented in a Point of Service (PoS). For example, in a broadband wireless communication system, an MIHF may be implemented in an Access Router (AC) or an Access Control Router (ACR) (hereinafter referred to as a base station). The PoS may be implemented in an MIHF, an MIH user or various software blocks such as a signal message processing block and a session and DB managing block.

Referring to FIG. 4, in step 400, a base station reads prefix information from a memory containing initial loading information, generates as many random addresses as the maximum MIHF_IP_Pool number, and stores the generated random addresses in the MIHF_IP_Pool. In step 402, the base station maps the generated random address to a dummy MAC address. In step 404, the base station transmits a message to a database to update IP information. In step 406, the base station updates address information. Herein, when terminal information is stored in an upper router, a terminal ID is used, and the terminal ID generally uses a MAC address of the terminal. Thus, the random address is mapped to the MAC address of the terminal in order to detect to which terminal it is allocated. The upper router knows beforehand an IPv6 prefix to be used in a subnet to be managed by it. Thus, the upper router stores a dummy MAC address and the random address where the prefix is stored in the MIHF_IP_Pool and assigns one of addresses of the MIHF_IP_Pool when an IPv6 address needs to be assigned to the terminal. If a dummy MAC address is assigned, it can be known that the address was not assigned to any terminal.

In step 408, the base station reads the NCoA generated by the terminal through an MIH_N2N_HO_Query_Resource Indication event (318), generates a DAD request message, and transmits the same to a DB.

In step 410, the base station detects whether an address is assigned and a MAC address is a dummy address. In step 412, the base station replaces a dummy MAC address with a MAC address of the terminal. Using a subnet prefix contained in the MIH_Get_Information from an information service server, an MIH user can generate an address and use the same.

In step 414, the base station deletes the assigned address from an MIH_IP_Pool and fills the MIH_IP_Pool by generating as many random addresses as the number of IPs reduced. In step 416, the base station releases the corresponding IP from the MIH_IP_Pool. The dummy MAC address is used to manage an address list in the MIHF_IP_Pool. If actually assigned, the dummy MAC address is replaced by a MAC address of the terminal, and it is removed by the Pool that manages an IP to be assigned. The Pool must be filled by as many as the number of IPs reduced because it cannot be extracted from the initially filled Pool.

In step 418, the base station detects a duplicate address to detect whether the NCoA is duplicated.

If the NCoA is duplicate in step 420, the base station selects an IP from the MIHF_IP_Pool in step 422 and notifies a new address through an MIH_N2N_HO_Query_Resource Response message (322). In step 424, the base station transmits the NCoA of the terminal. In step 426, the base station transmits IP information to the DB. In step 428, the base station updates address information.

If the NCoA is not duplicated, the base station transmits a null address or an original address through an MIH_N2N_HO_Query_Resource Response message (322) to notify that the address is not a duplicate. An MIH_N2N_HO_Query_Resource message has an IP_CONFIG_METHODS field indicating an IP configuration method and an option field containing addresses of AR, Foreign Agent (FA) and DHCP supporting IP configuration. Therefore, a value is set in an IP_CONFIG_METHODS field to notify that an address of the terminal is already generated, and an option filed is configured to notify a completed address. A message field correction on the standard draft is unnecessary, and the implementation is possible according to the development direction of an MIH user that is to receive and process the same.

As described above, an address mapped to a dummy MAC address is assigned. Therefore, the probability of duplicate use is very low, but it is again detected in a session, DB.

Thereafter, the DAD process of the present invention is ended.

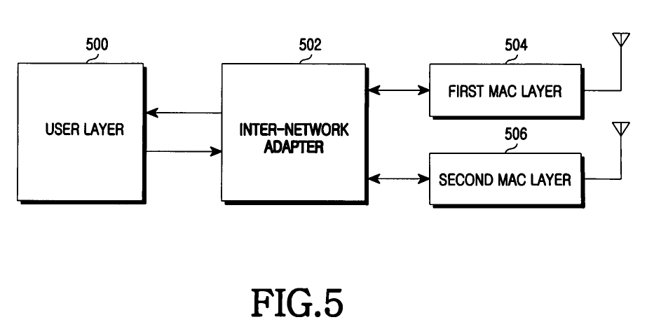

FIG. 5 is a block diagram of a user terminal according to an embodiment of the present invention.

Referring to FIG. 5, a user terminal includes a user layer 500, an inter-network adapter 502, a first MAC layer 504, and a second MAC layer 506.

The user layer 500 corresponds to an upper layer including mobility management protocol and operates as an entity using a service provided by an MIHF.

The user layer 500 generates a New Care of Address (NCoA) using information about a neighbor network. The user layer 500 transmits an MIH command necessary for a resource allocation request or an information query to the inter-network adapter 502 and receives an MIH event from the inter-network adapter 502. For example, the user layer 500 transmits an MIH command for an information request (MIH_Get_Information Request) and an MIH command for handover initiation (MIH_MN_HO_Candidate_Query Request) to the inter-network adapter 502.

The inter-network adapter 502 is implemented in a function of an MIH service. The inter-network adapter 502 serves as a Service Access Point (SAP) between the user layer 500 and the first MAC layer 504 and the second MAC layer 506. That is, the inter-network adapter 502 adapts different media interfaces of the first MAC layer 504 and the second MAC layer 506 to an MIH format to transmit the adapted media interfaces to the user layer 500, and adapts a signal from the user layer 500 to the corresponding media interface.

The user layer 500 transmits a message for an information request (MIH_Get_Information Request) and a message for handover initiation (MIH_MN_HO_Candidate_Query Request) through the first layer 504 or the second MAC layer 506.

The first MAC layer 504 and the second MAC layer 506 controls accesses to the corresponding media. For example, the first MAC layer 504 may access a cellular network such as CDMA or GSM, and the second MAC layer 506 may access a wireless LAN or a broadband wireless communication network (e.g., IEEE 802.16).

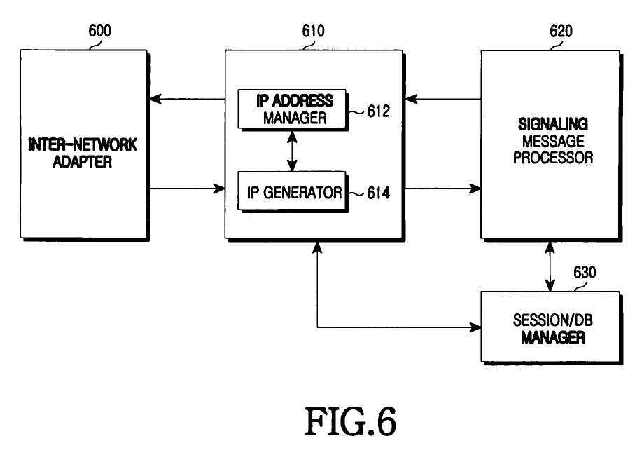

FIG. 6 is a block diagram of a base station according to an embodiment of the present invention.

Referring to FIG. 6, a base station includes an inter-network adapter 600, a user layer 610, a signaling message processor 620, and a session/DB manager 630.

The inter-network adapter 600 transmits a handover initiation event (MIH_MN_HO_Candidate_Query Indication) to the user layer 610 and transmits a message for a resource allocation request (MIH_N2N_HO_Resource Request) to a candidate network. The candidate network transmits an event for the resource allocation request (MIH_N2N_HO_Query_Resource Indication) to the user layer 610. Also, the candidate network transmits a response message for the resource allocation request (MIH_N2N_HO_Query_Resource Response) to a serving network and transmits an MIH command for a response event for the resource allocation request (MIH_N2N_HO_Query_Resource Confirm) to transmit a response message for the handover initiation (MIH_MN_HO_Candidate_Query Response) to a user terminal.

The user layer 610 has an IP address manager 612 and an IP generator 614, and performs Duplicate Address Detection (DAD) for an NCoA. For example, when an event for the resource allocation request occurs, the user layer 610 generates a DAD request message to obtain an NCoA of the user terminal. When the NCoA is a duplicate, the user layer 610 selects an IP from an MIHF_IP_Pool to transmit a new IP address. When the NCoA is not a duplicate, the user layer 610 transmits an original address or a null address.

The signaling message processor 620 transmits a message for an update of IP information from the user layer 610 to the session/DB manager 630.

The session/DB manager 630 determines whether the NCoA is assigned and an MAC address is a dummy address, replaces a dummy MAC address by a MAC address of the user terminal according to the determination results, deletes an address corresponding to the replaced MAC address from an IP_Pool, and releases an IP address from an MIH_IP Pool.

As described above, the present invention beforehand generates an Ipv6 address of a target network through an MIH service and also performs a DAD process for the address to prevent a delay taken to perform a DAD process in an Ipv6 layer, thereby making it possible to provide a seamless handover. The DAD process must be used because there is no way to register an Ipv6 address, which is generated using a stateless technique, in an Access Router (AR). However, the present invention can register the address in the AR without the use of a DAD process, thus making it possible to prevent a problem that may occur due to the loss of a Neighbor Solicitation (NS) message during the DAD process.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for assigning an Internet Protocol (IP) address in a communication system based on a Media Independent Handover (MIH), the method comprising:
obtaining information about a neighbor network through an MIH service;
generating, in the event of a handover to a heterogeneous network, at least one New Care of Address (NCoA) by using the information about the neighbor network;
transmitting the generated New Care of Address to a candidate network through the MIH service; and
performing a Duplicate Address Detection (DAD) operation on the New Care of Address.

2. The method of claim 1, wherein obtaining of the information about the neighbor network comprises:
transmitting an information request (MIH_Get_Information Request) message from an upper layer to a Media Independent Information Service (MIIS) server through an MIH command for information request; and
receiving a response message for information request (MIH_Get_Information Response) from the MIIS server to transmit an information confirmation MIH event to the upper layer.

3. The method of claim 1, wherein transmitting the generated New Care of Address comprises:
transmitting a message for handover initiation (MIH_MN_HO_Candidate_Query Request) to a serving network through an MIH command;
transmitting a message for a resource allocation request (MIN_N2N_HO_Resource Request) for a handover initiation event (MIH_MN_HO_Candidate_Query Indication) to a candidate network; and
transmitting an event for the resource allocation request (MIN_N2N_HO_Query_Resource Indication) to an upper layer.

4. The method of claim 1, wherein performing a DAD operation comprises:
assigning an address with reference to a New Care of Address of the user terminal when a resource allocation request event for a handover between heterogeneous networks occurs;
determining whether a MAC address of the assigned address is a dummy address, and replacing a dummy MAC address by a MAC address of the user terminal according to the determination results;
deleting the assigned address from an MIH_IP_Pool; and
determining whether the assigned address is a duplicate to transmit an MIH command.

5. The method of claim 4, wherein if the New Care of Address is a duplicate, an IP address is selected from the MIH_IP_Pool to transmit a new IP address; and
an original address or a null address is transmitted if the New Care of Address is not a duplicate.

6. The method of claim 4, further comprising:
generating as many random addresses as the number of IP addresses reduced by the address assignment to fill the MIH_IP_Pool.

7. The method of claim 4, further comprising:
generating as many random addresses as the initially set number from prefix information and storing the generated random addresses in the MIH_IP_Pool.

8. The method of claim 1, further comprising:
notifying the results of the DAD operation through an MIH service.

9. The method of claim 8, wherein notifying the results of the DAD operation comprises:
transmitting a response message for a resource allocation request (MIH_N2N_HO_Query_Resource Request) to a serving network through an MIH command after the DAD operation;
transmitting an MIH command for a response event for the resource allocation request (MIH_N2N_HO_Query_Resource Confirm) to transmit a response message for the handover initiation (MIH_MN_HO_Candidate_Query Response) to a user terminal; and
transmitting an MIH event for the response message for the handover initiation (MIH_MN_HO_Candidate_Query Confirm).

10. The method of claim 9, wherein the MIH_N2N_HO_Query_Resource message includes an IP_CONFIG_METHOD field indicating an IP configuration method and an option field for an address of a network entity supporting IP configuration.

11. A method for an operation of a user terminal to assign an Internet Protocol (IP) address in a communication system based on a Media Independent Handover (MIH), the method comprising:
obtaining information about a neighbor network through an MIH service;
generating, in the event of a handover to a heterogeneous network, at least one New Care of Address (NCoA) by using the information about the neighbor network; and
transmitting the generated New Care of Address to a candidate network through the MIH service.

12. A method for an operation of a base station to assign an Internet Protocol (IP) address in a communication system based on a Media Independent Handover (MIH), the method comprising:
receiving, in the event of a handover between heterogeneous networks, one or more New Care of Addresses (NCoAs) from a user terminal through an MIH service;
performing a Duplicate Address Detection (DAD) operation on the New Care of Address; and
notifying the results of the DAD operation to the user terminal.

13. A system for assigning an Internet Protocol (IP) address in a communication system based on a Media Independent Handover (MIH), the system comprising:
a user terminal for obtaining information about a neighbor network through an MIH service, generating, in the event of a handover between heterogeneous networks, one or more New Care of Addresses (NCoAs) by using the information about the neighbor network, and transmitting the generated New Care of Address to a candidate network through the MIH service; and
a candidate base station for performing a Duplicate Address Detection (DAD) operation on the New Care of Address.

14. The system of claim 13, wherein the user terminal transmits an information request (MIH_Get_Information Request) message from an upper layer to a Media Independent Information Service (MIIS) server through an MIH command for information request; and receives a response message for information request (MIH_Get_Information Response) from the MIIS server to transmit an information confirmation MIH event to the upper layer.

15. The system of claim 13, wherein the user terminal transmits a message for handover initiation (MIH_MN_HO_Candidate_Query Request) to a serving network through an MIH command; the serving network transmits an message for a resource allocation request (MIN_N2N_HO_Resource Request) for a handover initiation event (MIH_MN_HO_Candidate_Query Indication) to a candidate network; and the candidate network transmits an event for the resource allocation request (MIN_N2Query_Resource Indication) to an upper layer.

16. The system of claim 13, wherein the candidate base station assigns an address with reference to a New Care of Address of the user terminal when a resource allocation request event for a handover between heterogeneous networks occurs; determines whether a MAC address of the assigned address is a dummy address to replace a dummy MAC address by a MAC address of the user terminal according to the determination results; deletes the assigned address from an MIH_IP_Pool; and determines whether the assigned address is a duplicate to transmit an MIH command.

17. The system of claim 16, wherein if the New Care of Address is a duplicate, an IP address is selected from the MIH_IP_Pool to transmit a new IP address, and an original address or a null address is transmitted if the New Care of Address is not a duplicate.

18. The system of claim 16, wherein the candidate base station generates as many random addresses as the number of IP addresses reduced by the address assignment to fill the MIH_IP_Pool.

19. The system of claim 16, wherein the candidate base station generates as many random addresses as the initially set number from prefix information and stores the generated random addresses in the MIH_IP_Pool.

20. The system of claim 13, wherein the results of the DAD operation are notified through an MIH service.

21. The system of claim 20, wherein the candidate base station transmits a response message for a resource allocation request (MIH_N2N_HO_Query_Resource Request) to a serving network through an MIH command after the DAD operation; the serving network transmits an MIH command for a response event for the resource allocation request (MIH_N2N_HO_Query_Resource Confirm) to transmit a response message for the handover initiation (MIH_MN_HO_Candidate_Query Response) to the user terminal; and the user terminal transmits an MIH event for the response message for the handover initiation (MIH_MN_HO_Candidate_Query Confirm).

22. The system of claim 13, wherein the MIH_N2N_HOQuery_Resource message includes an IP_CONFIG_METHOD field indicating an IP configuration method and an option field for an address of a network entity supporting IP configuration.

23. An apparatus for a base station to assign an Internet Protocol (IP) address in a communication system based on a Media Independent Handover (MIH), the apparatus comprising:
an inter-network adapter for receiving, in the event of a handover between heterogeneous networks, one or more New Care of Addresses (NCoAs) from a user terminal through an MIH service; and
a user layer for performing a Duplicate Address Detection (DAD) operation on the New Care of Address and notifying the results of the DAD operation to the user terminal.

24. An apparatus for a user terminal to assign an Internet Protocol (IP) address in a communication system based on a Media Independent Handover (MIH), the apparatus comprising:
an inter-network adapter for obtaining information about a neighbor network through an MIH service; and
a user layer for generating, in the event of a handover to a heterogeneous network, one or more New Care of Addresses (NCoAs) by using the information about the neighbor network and transmitting the generated New Care of Address to a candidate network through the MIH service.
